(19) United States
(12) Patent Application Publication
(10) Pub. No.: US 2004/0197629 A1
(43) Pub. Date: Oct. 7, 2004

(54) Electric power generating element for fuel cell and fuel cell using the same

(76) Inventors: Yasuo Arishima, Kyoto-shi (JP); Shingo Nakamura, Itami-shi (JP); Hiroshi Kashino, Osaka (JP); Shinsuke Shibata, Osaka (JP); Shoji Saibara, Osaka (JP)

Correspondence Address: ROSENTHAL & OSHA L.L.P., Suite 2800, 1221 McKinney, Houston, TX, 77010, US

(21) Appl. No.: 10/761,128

(22) Filed: Jan. 20, 2004

(30) Foreign Application Priority Data
Jan. 20, 2003 (JP) 2003-011587

(51) Int. Cl. H01M 8/10; H01M 2/00; H01M 2/02; H01M 2/08; H01M 4/86; H01M 4/90; H01M 4/96

(52) U.S. Cl. 429/30; 429/34; 429/35; 429/40; 429/41; 429/42

(57) ABSTRACT

An electric power generating element for a fuel cell includes a positive electrode for reducing oxygen, a negative electrode for oxidizing a fuel, and a solid electrolyte provided between the positive electrode and the negative electrode. The positive electrode and the negative electrode include a laminate of two or more electrode layers containing a catalyst. Each of the electrode layers has a thickness of 50 μm or less, and an adhesive layer is disposed between the electrode layers. In this way, it is possible to provide an electric power generating element for a fuel cell that can both thicken an electrode layer and achieve a porous structure and a structural flawlessness of the electrode layer.

### BACKGROUND OF THE INVENTION

1. Field of the Invention

The present invention relates to an electric power generating element for a fuel cell and a fuel cell using the same. In particular, the present invention relates to an electric power generating element for a fuel cell using a liquid fuel such as methanol, and a fuel cell using the same.

2. Description of Related Art

In recent years, along with the widespread use of cordless equipment such as personal computers and cellular phones, a smaller and higher-capacity secondary battery serving as a power source thereof has been much in demand. At present, as a secondary battery that has a high energy density and can be reduced in size and weight, a lithium ion secondary battery is being commercialized. The demand therefor as a portable power source is increasing. However, depending on the kinds of cordless equipment to be used, this lithium secondary battery has not yet been able to guarantee sufficient hours of continuous use.

Under such circumstances, as a battery capable of satisfying the above-described demand, a polymer electrolyte fuel cell using a solid polymer electrolyte as its electrolyte, oxygen in the air as its positive active material and a fuel such as hydrogen or methanol as its negative active material has attracted attention because it is expected to achieve a higher energy density than the lithium ion secondary battery. In particular, a direct methanol fuel cell that directly utilizes methanol, which is a liquid fuel, for battery reaction can be miniaturized because there is no need to use a blower for supplying the air to a cell main body or a pump for supplying fuel thereto. Accordingly, the direct methanol fuel cell holds a great promise as a future portable power source (see JP 2000-268836 A).

Further, technical documents related to the invention of the present application include JP 2002-184415 A, JP 10(1998)-189004 A, JP 11(1999)-288727 A and JP 2002-15743 A.

However, since the direct methanol fuel cell has a very slow methanol oxidation speed in the negative electrode, it is necessary to increase the amount of negative electrode catalyst and expand the surface area for reaction for compensating this slow speed. Also, when a proton-conducting solid polymer film or the like is used as the solid polymer electrolyte, there occurs a crossover phenomenon in which the liquid fuel such as methanol passes through an electrolyte film to the side of the positive electrode. When this phenomenon occurs, a direct reaction between methanol and oxygen (combustion) occurs on the positive electrode catalyst, thus reducing the surface area of catalyst that is used for reduction of oxygen in the positive electrode, which essentially is a battery reaction. In order to compensate for this loss, it is necessary to increase the amount of positive electrode catalyst as in the case of negative electrode. If there arose no problem of crossover, the amount of positive electrode catalyst could be reduced. However, a required amount of platinum catalyst generally is 5 to 15 mg/cm² for both the positive and negative electrodes, which is larger than the amount of platinum catalyst necessary when using hydrogen as a fuel (0.3 to 0.5 mg/cm²).

In order to increase the catalyst amount in an electrode layer, it is essential to thicken the electrode layer. Also, in the electrode layer of the fuel cell, what is at least equally as important as this thickening is that the fuel and oxygen can distribute excellently and move through the electrode layer. For this purpose, the electrode layer needs to have a relatively uniform porous structure and be structurally free of flaws such as cracks (hereinafter, referred to as a structural flawlessness).

However, when the thickening is attempted by a method of applying the electrode layer to a substrate for increasing the catalyst amount, the surface of the applied electrode layer dries faster than the inner part thereof. Therefore, large cracks are made easily on the surface of the electrode layer, and in some cases, the electrode layer even peels off or falls off from the electrode substrate. These phenomena impair the porous structure and the structural flawlessness necessary for the electrode layer, resulting in an adverse effect on cell characteristics. As one solution for this problem, JP 2002-184415 A has suggested that a porous electrode substrate be used to accelerate a drying process, thereby suppressing the generation of cracks. However, it is still difficult to respond to the thickening of the electrode layer up to about 30 to 300 μm necessary for the direct methanol fuel cell.

### SUMMARY OF THE INVENTION

The present invention provides an electric power generating element for fuel cell that can both thicken an electrode layer and achieve a porous structure and a structural flawlessness of the electrode layer, and a fuel cell using the same.

The present invention provides an electric power generating element for a fuel cell including a positive electrode for reducing oxygen, a negative electrode for oxidizing a fuel, and a solid electrolyte provided between the positive electrode and the negative electrode. At least one selected from the positive electrode and the negative electrode includes a laminate of two or more electrode layers containing a catalyst. Each of the electrode layers has a thickness of 50 μm or less, and an adhesive layer is disposed between the electrode layers.

Also, the present invention provides an electric power generating element for a fuel cell including a positive electrode for reducing oxygen, a negative electrode for oxidizing a fuel, and a solid electrolyte provided between the positive electrode and the negative electrode. At least one selected from the positive electrode and the negative electrode includes a laminate of two or more electrode layers containing a catalyst and a polymer material having a proton conducting property. Each of the electrode layers has a thickness of 50 μm or less, and the polymer material is present more in an interface part of each of the electrode layers than in an inner part thereof.

Further, the present invention provides a fuel cell including an electric power generating element for a fuel cell including a positive electrode for reducing oxygen, a negative electrode for oxidizing a fuel, and a solid electrolyte provided between the positive electrode and the negative electrode. At least one selected from the positive electrode and the negative electrode includes a laminate of two or more electrode layers containing a catalyst. Each of the electrode layers has a thickness of 50 μm or less, and an adhesive layer is disposed between the electrode layers.

Moreover, the present invention provides a fuel cell including an electric power generating element for a fuel cell including a positive electrode for reducing oxygen, a negative electrode for oxidizing a fuel, and a solid electrolyte provided between the positive electrode and the negative electrode. At least one selected from the positive electrode and the negative electrode includes a laminate of two or more electrode layers containing a catalyst and a polymer material having a proton conducting property. Each of the electrode layers has a thickness of 50 μm or less, and the polymer material is present more in an interface part of each of the electrode layers than in an inner part thereof.

### BRIEF DESCRIPTION OF THE DRAWINGS

FIG. 1 shows a schematic cross-section of an example of an electric power generating element for a fuel cell according to the present invention.

FIG. 2 shows a schematic cross-section of another example of the electric power generating element for a fuel cell according to the present invention.

FIG. 3 shows a schematic cross-section of an electric power generating element for a fuel cell according to Comparative Example 1.

FIG. 4 shows a schematic cross-section of an electric power generating element for a fuel cell according to Comparative Example 2.

FIG. 5 shows a schematic cross-section of a single cell for fuel cell evaluation before combining individual components.

### DESCRIPTION OF THE PREFERRED EMBODIMENTS

The following is a description of embodiments of the present invention.

First, an embodiment of an electric power generating element for a fuel cell according to the present invention will be described. The electric power generating element for a fuel cell in the present embodiment includes a positive electrode for reducing oxygen, a negative electrode for oxidizing a fuel and a solid electrolyte provided between the positive electrode and the negative electrode. At least the negative electrode includes a laminate of two or more electrode layers containing a catalyst. Each of the electrode layers has a thickness of 50 μm or less, preferably 45 μm or less and more preferably 40 μm or less. An adhesive layer is disposed between these electrode layers. In order not to increase too much the number of the electrode layers to be laminated, the lower limit of the thickness of each electrode layer preferably is 10 μm or more, and more preferably is 30 μm or more. Further, in terms of the crossover phenomenon described above, it is desired that not only the negative electrode but also the positive electrode should include a laminate similar to the one described above. Moreover, the electrode layer and the adhesive layer both have a proton conducting property and an electron conducting property.

This makes it possible to laminate the electrode layers while keeping the thickness of each electrode layer within the range capable of maintaining the porous structure and the structural flawlessness. Thus, even when the total thickness of the electrode layers is increased to contain more catalyst, the porous structure and the structural flawlessness of the entire electrode are not lost. The thickness in the range not greater than 50 μm allows each electrode layer to maintain its porous structure and structural flawlessness reliably, though it varies depending on materials contained in the electrode layer. Furthermore, the adhesive layer disposed between the electrode layers joins these electrode layers while keeping the proton conducting property and the electron conducting property and allows easy formation of the laminate.

Incidentally, although JP 10(1998)-189004 A, JP 11(1999)-288727 A and JP 2002-15743 A mentioned earlier also describe an electrode having a layered structure, none of them aims to thicken the electrode. Also, they adopt a technique of forming the layered structure by repeated applications and have a limitation in thickening the electrode.

In addition, an embodiment of a fuel cell according the present invention uses the electric power generating element for a fuel cell described in the above embodiment.

Next, an embodiment of a method for manufacturing an electric power generating element for a fuel cell according to the present invention will be described. The present embodiment includes a first process of disposing an adhesive layer on a releasable substrate, a second process of disposing an electrode layer containing a catalyst and having a thickness of 50 μm or less on the adhesive layer, a third process of bringing the electrode layer and a solid electrolyte into contact with each other, a fourth process of making the electrode layer and the solid electrolyte adhere to each other by compressing while heating, a fifth process of peeling off the releasable substrate so as to expose the adhesive layer, a sixth process of disposing another electrode layer containing a catalyst and having a thickness of 50 μm or less on the exposed adhesive layer, and a seventh process of making those adhesive layer and electrode layer adhere to each other by compressing while heating.

Moreover, the present embodiment also can form a laminate of three or more layers by including one or more further processes of disposing on the exposed adhesive layer a second electrode layer formed separately by the above-described first and second processes, making these adhesive layer and second electrode layer adhere to each other by compressing while heating, and then peeling off the releasable substrate so as to expose the adhesive layer, between the fifth process and the sixth process.

Another embodiment of the method for manufacturing an electric power generating element for a fuel cell according to the present invention includes a first process of disposing an electrode layer containing a catalyst and having a thickness of 50 μm or less on a releasable substrate, a second process of bringing the electrode layer and a solid electrolyte into contact with each other, a third process of making the electrode layer and the solid electrolyte adhere to each other by compressing while heating, a fourth process of peeling off the releasable substrate so as to expose the electrode layer, a fifth process of disposing an adhesive layer on the exposed electrode layer, a sixth process of disposing another electrode layer containing a catalyst and having a thickness of 50 μm or less on the adhesive layer, and a seventh process of making those adhesive layer and electrode layer adhere to each other by compressing while heating.

Moreover, the present embodiment also can form a laminate of three or more layers by including one or more further processes of disposing on the adhesive layer a second electrode layer formed separately by the above-described first process, making these adhesive layer and second electrode layer adhere to each other by compressing while heating, peeling off the releasable substrate so as to expose the second electrode layer, and then disposing further an adhesive layer on the exposed second electrode layer, between the fifth process and the sixth process.

With the above-described manufacturing method, it is possible to laminate the electrode layers while keeping the thickness of each electrode layer within the range capable of maintaining the porous structure and the structural flawlessness. Thus, even when the total thickness of the electrode layers is increased to contain more catalyst, an electric power generating element for a fuel cell can be manufactured without losing the porous structure and the structural flawlessness of the entire electrode. In other words, the manufacturing method of the present embodiment can form an electrode laminate simply by transferring electrode layers having a porous structure and a structural flawlessness sequentially onto a solid electrolyte.

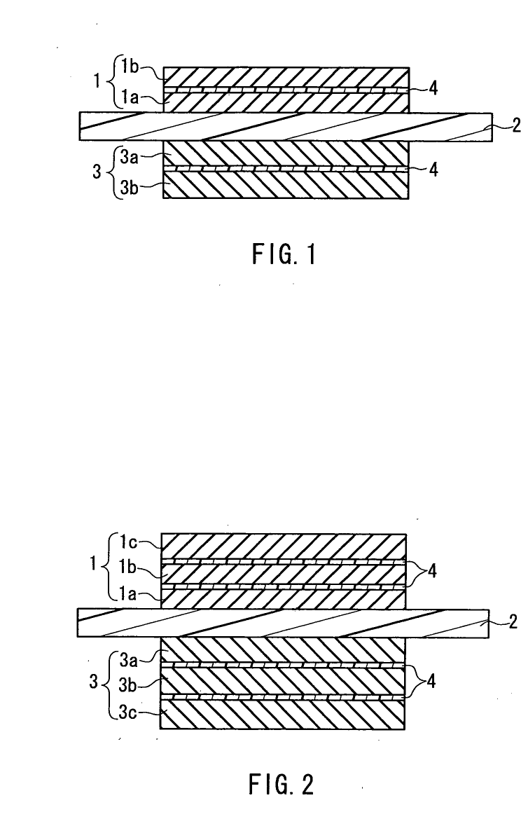

The following is a description of an electric power generating element for a fuel cell according to the present invention, with reference to the accompanying drawings. FIG. 1 shows a schematic cross-section of an example of the electric power generating element for a fuel cell according to the present invention. In FIG. 1, this electric power generating element for a fuel cell includes a positive electrode 1 for reducing oxygen, a negative electrode 3 for oxidizing a fuel and a solid polymer electrolyte film 2 provided between the positive electrode 1 and the negative electrode 3. The positive electrode 1 is formed by laminating a positive electrode layer 1a, an adhesive layer 4 and a positive electrode layer 1b in this order. Similarly to the positive electrode 1, the negative electrode 3 is formed by laminating a negative electrode layer 3a, an adhesive layer 4 and a negative electrode layer 3b in this order.

FIG. 2 shows a schematic cross-section of another example of the electric power generating element for a fuel cell according to the present invention. In FIG. 2, this electric power generating element for a fuel cell includes a positive electrode 1 for reducing oxygen, a negative electrode 3 for oxidizing a fuel and a solid polymer electrolyte film 2 provided between the positive electrode 1 and the negative electrode 3. The positive electrode 1 is formed by laminating a positive electrode layer 1a, an adhesive layer 4, a positive electrode layer 1b, an adhesive layer 4 and a positive electrode layer 1c in this order. Similarly to the positive electrode 1, the negative electrode 3 is formed by laminating a negative electrode layer 3a, an adhesive layer 4, a negative electrode layer 3b, an adhesive layer 4 and a negative electrode layer 3c in this order.

The adhesive layer 4 can be made of an adhesive material having a proton conducting property alone or having both a proton conducting property and an electron conducting property. In the case of using an adhesive material having a proton conducting property alone for the adhesive layer, it eventually is necessary to provide this adhesive layer with an electron conducting property as well by another method such as diffusing an electrically conductive material contained in the electrode layer into the adhesive layer as described later.

The adhesive material having a proton conducting property alone can be a proton-conducting polymer material or a mixed material of a highly-adhesive polymer material and a proton-conducting polymer material. Examples of the proton-conducting polymer material include a polyperfluorosulfonic acid resin, a sulfonated polyethersulfonic acid resin, a sulfonated polyimide resin, a styrene-divinylbenzenesulfonic acid resin and the like. The highly-adhesive polymer material to be mixed with this proton-conducting polymer material can be, for example, polystyrene, polyacrylonitrile, polyethylene terephthalate (PET) or polyvinyl acetate.

The adhesive material having both a proton conducting property and an electron conducting property can be a polymer material having a proton conducting property and an electron conducting property or a mixed material of an electron-conducting polymer material and the above-mentioned proton-conducting polymer material. Examples of the polymer material having a proton conducting property and an electron conducting property include (alkyl)sulfonated polyaniline, (alkyl)sulfonated polypyrrole, (alkyl)sulfonated polythiophene, (alkyl)sulfonated poly-p-phenylene, (alkyl)sulfonated polyfuran and the like. The electron-conducting polymer material can be, for example, polyaniline, alkyl polyaniline, alkyl polypyrrole, alkyl polythiophene, alkyl poly-p-phenylene or alkyl polyfuran.

The negative electrode layers 3a to 3c can be formed of a catalyst, an electrically conductive material and a polymer material. The catalyst contained in this negative electrode layers can be a catalyst having a function of generating protons from a fuel, in other words, a function of electrochemically oxidizing the fuel. For example, fine particles of platinum alone or fine particles of an alloy of platinum and ruthenium, indium, iridium, tin, iron, titanium, gold, silver, chromium, silicon, zinc, manganese, molybdenum, tungsten, rhenium, aluminum, lead, palladium or osmium can be used. The electrically conductive material mainly can be a carbon material, for example, carbon black, activated carbon, carbon nanotube, carbon nanohorn or the like. In general, the catalyst and the electrically conductive material are used as a catalyst carrying carbon in which the catalyst is dispersed in and carried by the surface of the electrically conductive material.

As the polymer material contained in the negative electrode layers 3a to 3c, a material having a proton conducting property alone or a material having both a proton conducting property and an electron conducting property can be used. Such a material preferably is a polymer material similar to the polymer material used for the adhesive layer 4 so that a contact resistance (an interface resistance) can be reduced between the adhesive layer and the electrode layer.

Furthermore, the negative electrode layers 3a to 3c sometimes can contain a polytetrafluoroethylene (PTFE) resin, a polyvinylidene fluoride (PVDF) resin or a polyethylene (PE) resin as a binder.

The positive electrode layers 1a to 1c also can be formed of a catalyst, an electrically conductive material and a polymer material. The catalyst contained in these positive electrode layers can be a catalyst having a function of electrochemically reducing the oxygen. For example, platinum fine particles or fine particles of an alloy of platinum and iron, nickel, cobalt, tin, ruthenium or gold. The electrically conductive material, the polymer material and the binder can be similar to those for the negative electrode.

The solid polymer electrolyte film 2 disposed between the positive electrode 1 and the negative electrode 3 can be formed of a material having a proton conducting property alone and no electron conducting property. For example, a polyperfluorosulfonic acid resin film, more specifically, “Nafion” (trade name) manufactured by DuPont. Co., “Flemion” (trade name) manufactured by ASAHI GLASS CO., LTD. or “Aciplex” (trade name) manufactured by Asahi Kasei Corporation can be used. Other than the above, it also may be possible to use a sulfonated polyethersulfonic acid film, a sulfonated polyimide resin film, a sulfuric acid-doped polybenzimidazole film, a phosphoric acid-doped SiO₂ film known as a solid electrolyte, a hybrid film of a polymer and a solid electrolyte, or a gel electrolyte film obtained by impregnating a polymer and an oxide with an acid solution.

Now, a first embodiment of the method for manufacturing an electric power generating element for a fuel cell according to the present invention will be described. First, in the present embodiment, an electrode paste used for forming the electrode layers is prepared. This electrode paste is prepared by dissolving and dispersing the catalyst, the electrically conductive material and the polymer material, and further the binder as necessary, into a solvent containing a lower alcohol such as ethanol or propanol as a principal component, followed by stirring sufficiently.

In a separate process, the releasable substrate whose surface is provided with the adhesive layer is prepared. This releasable substrate can be, for example, a PTFE film, a PET film, a polyimide film, a PTFE-coated polyimide film, a PTFE-coated silicon sheet or a PTFE-coated glass cloth. It is preferable that the adhesive layer provided on this releasable substrate has a thickness ranging from 1 to 5 μm. The reason is that, within this range, it is possible to produce a sufficient function as the adhesive layer, allowing an excellent layer transfer of the electrode layer, and it is easier for the electrically conductive material contained in the electrode layer described later to be diffused into the adhesive layer, so that an electron resistance does not rise, allowing a reduction in a diffusion resistance of oxygen and fuel.

The adhesive material used for the adhesive layer can be either the adhesive material having a proton conducting property alone or the adhesive material having both a proton conducting property and an electron conducting property described above.

Next, on the adhesive layer provided on this releasable substrate, the above-described electrode paste is applied and dried, thereby forming the electrode layer. The resultant electrode layer has a thickness of 10 to 50 μm, which is the range capable of keeping a certain amount of catalyst without losing the porous structure and the structural flawlessness of the electrode layer. It is preferable that the amount of catalyst contained in the electrode layer (the mass per unit area of the electrode) ranges from 0.3 to 3 mg/cm². This is because, within this range, a necessary amount of catalyst can be secured without increasing the number of total electrode layers.

Thereafter, the electrode layer formed on the releasable substrate via the adhesive layer is cut together with the releasable substrate into a predetermined size and overlaid on both surfaces of the solid polymer electrolyte film such that the electrode layer side faces the solid polymer electrolyte film, thus transferring and joining the electrode layer onto the solid polymer electrolyte film by hot pressing or hot roller pressing. Subsequently, the releasable substrate is peeled off, thus obtaining an electric power generating element precursor by the first transfer.

Then, the electrode layer produced similarly to the above is overlaid on the adhesive layers exposed on both surfaces of the electric power generating element precursor, followed by the second hot pressing or hot roller pressing. In this manner, the electrode layer can be transferred and joined to the electric power generating element precursor similarly to the above. In this obtained electric power generating element precursor, since the electrode layer and the adhesive layer intermix in their joint portion, it is possible to provide also the adhesive layer with an electron conducting property by the diffusion of the electrically conductive material contained in the electrode layer even when using the material having a proton conducting property alone for the adhesive layer. Thus, in the present embodiment, it is appropriate that the polymer material used for the adhesive layer has at least a proton conducting property and need not have an electron conducting property.

After repeating these operations several times, finally, the releasable substrate on which the electrode layer alone is formed is transferred and joined, thereby producing an electric power generating element for a fuel cell that both thickens electrodes and achieves the porous structure and the structural flawlessness.

Each of the final positive and negative electrodes of the above-described electric power generating element for a fuel cell preferably has a total thickness ranging from 30 to 300 μm and more preferably has a total thickness ranging from 70 to 300 μm. The thickness within this range can secure the amount of catalyst necessary for obtaining sufficient cell characteristics and causes no problem in the diffusion of oxygen and fuel.

Now, a second embodiment of the method for manufacturing an electric power generating element for a fuel cell according to the present invention will be described. In the present embodiment, the electrode paste used for forming the electrode layer also is prepared similarly to the above embodiment. Next, on the releasable substrate similar to the above, the electrode paste alone is applied and dried, thereby forming the electrode layer. The resultant electrode layer has a thickness of 10 to 50 μm, which is the range capable of keeping a certain amount of catalyst without losing the porous structure and the structural flawlessness of the electrode layer. The amount of catalyst contained in the electrode layer (the mass per unit area of the electrode) is set to range from 0.3 to 3 mg/cm² as in the above embodiment.

Thereafter, the electrode layer formed on the releasable substrate is cut together with the releasable substrate into a predetermined size and overlaid on both surfaces of the solid polymer electrolyte film such that the electrode layer side faces the solid polymer electrolyte film, thus transferring and joining the electrode layer onto the solid polymer electrolyte film by hot pressing or hot roller pressing. Subsequently, the releasable substrate is peeled off, thus obtaining an electric power generating element precursor by the first transfer.

Then, the electrode layer produced similarly to the above is overlaid on both surfaces of the electric power generating element precursor, followed by the second hot pressing or hot roller pressing. At this time, a thin film including a separately prepared electrode and an adhesive layer with the same size is disposed between the electric power generating element precursor and the electrode layer. In this manner, this thin film serves as an adhesive layer, so that the electrode layer can be transferred and joined to the electric power generating element precursor. In this obtained electric power generating element precursor, since the electrode layer and the adhesive layer sometimes are difficult to intermix in their joint portion, it is desired in the present embodiment that the polymer material used for the adhesive layer has both a proton conducting property and an electron conducting property.

It is preferable that the above-mentioned thin film of the adhesive layer has a thickness ranging from 1 to 5 μm. The reason is that, within this range, it is possible to produce a sufficient function as the adhesive layer, allowing an excellent layer transfer of the electrode layer, and an electron resistance does not rise, allowing a reduction in a diffusion resistance of oxygen and fuel.

After repeating these operations several times, an electric power generating element for a fuel cell that both thickens electrodes and achieves the porous structure and the structural flawlessness is produced.

Each of the final electrodes of the above-described electric power generating element for a fuel cell preferably has a total thickness ranging from 30 to 300 μm and more preferably has a total thickness ranging from 70 to 300 μm, as in the above case.

In the electrode laminate of the negative and positive electrodes produced as above, the polymer material with a proton conducting property is present more in an interface part of each electrode layer than in an inner part thereof Accordingly, the interface part in which the polymer material concentrates functions as the adhesive layer, making it possible to integrate the individual electrode layers preferably to provide a laminate.

Furthermore, the structure of each electrode layer may be different. It also may be possible to produce desired electrode characteristics by changing the kind or amount of catalyst for each electrode layer or changing the thickness of each electrode layer.

Although the embodiments of the present invention have been discussed in the above description, the present invention is not limited to the above embodiments.

In the following, the present invention will be described by way of examples.

### EXAMPLE 1

An electric power generating element for a fuel cell with a structure similar to that shown in FIG. 1 was produced by the following procedure.

For a positive electrode, 1 part by mass of platinum carrying carbon “10E50E” (trade name) manufactured by Tanaka Kikinzoku Kogyo K.K. in which 50% by mass of platinum was carried as a catalyst was added to 12 parts by mass of a solution of “Nafion” (trade name, EW=1000) manufactured by Sigma-Aldrich, Inc., which was a 5% by mass solution of a polyperfluorosulfonic acid resin, and 1 part by mass of water. Then, the mixed solution was stirred sufficiently to allow uniform dispersion, thereby preparing an electrode paste. Incidentally, the above-noted EW indicates the equivalent mass of an ion exchange group having a proton conducting property (in the present example, a sulfonic acid group). The equivalent mass is a dry mass of an ion exchange resin per equivalent mass of the ion exchange group and expressed by the unit “g/ew.”

Next, a PTFE film whose surface was provided with an adhesive layer by applying the above-mentioned “Nafion” solution in a thickness of 5 μm was prepared. On this adhesive layer, the above-described electrode paste was applied and dried, thus obtaining an electrode layer having a catalyst carrying amount of 1.0 mg/cm² and a thickness of 30 μm. This electrode layer was cut into a predetermined size, thus obtaining a positive electrode layer A1.

For a negative electrode, an electrode layer having a catalyst carrying amount of 1.0 mg/cm² and a thickness of 35 μm was obtained in a manner similar to that for the positive electrode described above except that platinum-ruthenium alloy carrying carbon “61V33” (trade name) manufactured by Tanaka Kikinzoku Kogyo K.K. in which 33% by mass of an alloy of platinum and ruthenium (mass ratio of the alloy was 1:1) was carried was used as the catalyst. This electrode layer was cut into a predetermined size in a manner similar to that for the positive electrode, thus obtaining a negative electrode layer B1.

For a solid polymer electrolyte film (hereinafter, referred to as an electrolyte film), a polyperfluorosulfonic acid resin film “Nafion 112” (trade name) manufactured by DuPont. Co. was cut into a predetermined size and used.

The positive electrode layer A1 and the negative electrode layer B1 that had been produced were overlaid on both surfaces of this electrolyte film such that the electrode side faced the electrolyte film, and hot-pressed at 160° C. at 4.4 MPa so as to join them. Thereafter, the PTFE films on both surfaces were peeled off, thus obtaining an electric power generating element precursor C1.

Subsequently, a positive electrode layer A2 and a negative electrode layer B2 that had been produced in a manner similar to the above except that a PTFE film whose surface was not provided with an adhesive layer was used were overlaid on both surfaces of this electric power generating element precursor C1 such that the electrode side faced the electric power generating element precursor and the electrodes with the same polarity were arranged on the same side with respect to the electrolyte film, and hot-pressed for the second time at 160° C. at 4.4 MPa so as to join them. Thereafter, the PTFE films on both surfaces were peeled off, thus obtaining an electric power generating element for a fuel cell whose positive and negative electrodes respectively included two electrode layers.

In this electric power generating element, the positive electrode and the negative electrode had a thickness of 65 μm and 75 μm, respectively. In addition, the catalyst amount was 2.0 mg/cm² for both of the positive and negative electrodes since two electrode layers each having a catalyst amount of 1.0 mg/cm² were laminated.

### EXAMPLE 2

An electric power generating element for a fuel cell with a structure similar to that shown in FIG. 2 was produced by the following procedure.

The positive electrode layer A1 and the negative electrode layer B1 that had been produced in a manner similar to Example 1 were overlaid on both surfaces of the electric power generating element precursor C1 that had been produced in a manner similar to Example 1 such that the electrode side faced the electrolyte film, and hot-pressed at 160° C. at 4.4 MPa so as to join them. Thereafter, the PTFE films on both surfaces were peeled off, thus obtaining an electric power generating element precursor C2.

Next, the positive electrode layer A2 and the negative electrode layer B2 that had been produced in a manner similar to Example 1 were overlaid on both surfaces of this electric power generating element precursor C2 such that the electrode side faced the electric power generating element precursor, and hot-pressed for the third time at 160° C. at 4.4 MPa so as to join them. Thereafter, the PTFE films on both surfaces were peeled off, thus obtaining an electric power generating element for a fuel cell whose positive and negative electrodes respectively included three electrode layers.

In this electric power generating element, the positive electrode and the negative electrode had a thickness of 100 μm and 115 μm, respectively. In addition, the catalyst amount was 3.0 mg/cm² for both of the positive and negative electrodes since three electrode layers each having a catalyst amount of 1.0 mg/cm² were laminated.

### EXAMPLE 3

An electric power generating element for a fuel cell with a structure similar to that shown in FIG. 1 was produced by the following procedure.

The positive electrode layer A2 and the negative electrode layer B2 that had been produced in a manner similar to Example 1 were overlaid on both surfaces of the electrolyte film similar to that in Example 1 such that the electrode side faced the electrolyte film, and hot-pressed at 160° C. at 4.4 MPa so as to join them. Thereafter, the PTFE films on both surfaces were peeled off, thus obtaining an electric power generating element precursor C3.

Next, a 5 μm thick thin film formed of a mixed resin of polyaniline and a polyperfluorosulfonic acid resin was prepared as an adhesive layer and cut into the same size as the electrodes, thus preparing a solid electrolyte film D.

Subsequently, this solid electrolyte film D was overlaid on both electrode surfaces of the electric power generating element precursor C3. Then, the positive electrode layer A2 and the negative electrode layer B2 that had been produced in a manner similar to Example 1 further were placed thereon such that the electrode side faced the electric power generating element precursor, and hot-pressed for the second time at 160° C. at 4.4 MPa so as to join them. Thereafter, the PTFE films on both surfaces were peeled off, thus obtaining an electric power generating element for a fuel cell including two electrode layers.

In this electric power generating element, the positive electrode and the negative electrode had a thickness of 65 μm and 75 μm, respectively. In addition, the catalyst amount was 2.0 mg/cm² for both of the positive and negative electrodes since two electrode layers each having a catalyst amount of 1.0 mg/cm² were laminated.

### EXAMPLE 4

An electric power generating element for a fuel cell with a structure similar to that shown in FIG. 2 was produced by the following procedure.

The solid electrolyte film D similar to that in Example 3 was overlaid on both surfaces of the electric power generating element for a fuel cell that had been produced in a manner similar to Example 3. Then, the positive electrode layer A2 and the negative electrode layer B2 that had been produced in a manner similar to Example 1 further were placed thereon such that the electrode side faced the electric power generating element, and hot-pressed for the third time at 160° C. at 4.4 MPa so as to join them. Thereafter, the PTFE films on both surfaces were peeled off, thus obtaining an electric power generating element for a fuel cell including three electrode layers.

In this electric power generating element, the positive electrode and the negative electrode had a thickness of 100 μm and 115 μm, respectively. In addition, the catalyst amount was 3.0 mg/cm² for both of the positive and negative electrodes since three electrode layers each having a catalyst amount of 1.0 mg/cm² were laminated.

### COMPARATIVE EXAMPLE 1

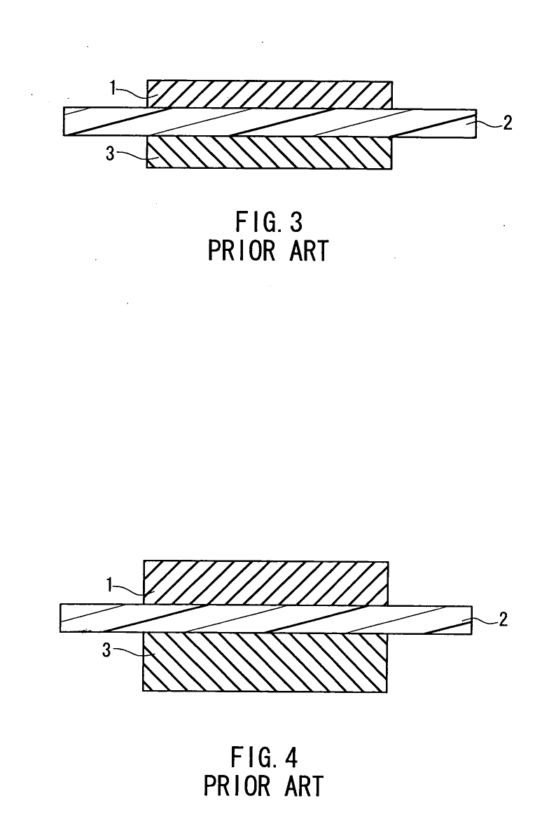

FIG. 3 shows a schematic cross-section of an electric power generating element for a fuel cell according to Comparative Example 1 including the positive electrode 1, the negative electrode 3 and the solid polymer electrolyte film 2 each having a single layer structure. This electric power generating element for a fuel cell was the electric power generating element precursor C3 produced in a manner similar to Example 3 used as it was as a electric power generating element.

In this electric power generating element, the positive electrode and the negative electrode had a thickness of 30 μm and 35 μm, respectively. In addition, the catalyst amount was 1.0 mg/cm² for both of the positive and negative electrodes since an electrode layer having a catalyst amount of 1.0 mg/cm² was used with its single layer structure.

### COMPARATIVE EXAMPLE 2

FIG. 4 shows a schematic cross-section of an electric power generating element for a fuel cell according to Comparative Example 2 including the positive electrode 1, the negative electrode 3 and the solid polymer electrolyte film 2 each having a single layer structure. This electric power generating element for a fuel cell was produced in a manner similar to Comparative Example 1 except that a positive electrode layer having a catalyst carrying amount of 2.0 mg/cm² and a thickness of 65 μm and a negative electrode layer having a catalyst carrying amount of 2.0 mg/cm² and a thickness of 75 μm were used.

In addition, the catalyst amount was 2.0 mg/cm² for both of the positive and negative electrodes since an electrode layer having a catalyst amount of 2.0 mg/cm² was used with its single layer structure.

### COMPARATIVE EXAMPLE 3

In Comparative Example 3, an attempt was made to produce an electric power generating element for a fuel cell in a manner similar to Comparative Example 1 except that a positive electrode layer having a catalyst carrying amount of 3.0 mg/cm² and a thickness of 100 μm and a negative electrode layer having a catalyst carrying amount of 3.0 mg/cm² and a thickness of 115 μm were used. However, in the process of thickening the electrode layers, innumerable cracks were made on the surface of the electrode layers, and the electrode layers peeled off and fell off from the PTFE film. Thus, it was not possible to produce the electrode layers according to the production conditions of this Comparative Example.

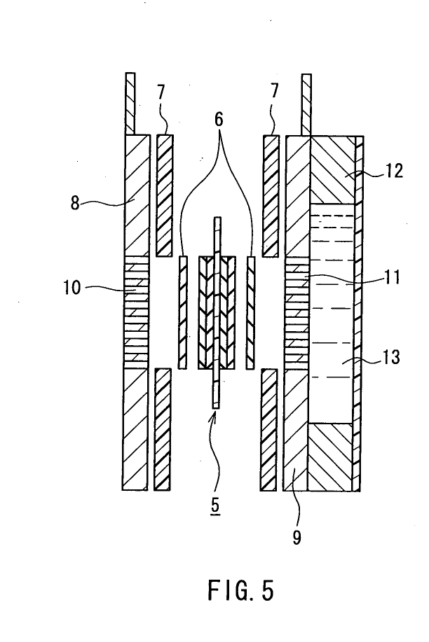

The electric power generating elements for a fuel cell of Examples 1 to 4 and Comparative Examples 1 and 2 described above were incorporated into a single cell for fuel cell evaluation together with gas diffusion layers serving also as a current collector, and evaluation tests were conducted. FIG. 5 shows a schematic cross-section of the single cell for fuel cell evaluation before combining individual components. On both sides of an electric power generating element 5 for a fuel cell, diffusion layers 6 formed of a carbon cloth were placed, while surrounded by sealing materials 7 formed of silicone rubber. Further, on both sides thereof, a positive electrode collector plate 8 made of stainless steel having oxygen inflow holes 10 and a negative electrode collector plate 9 made of stainless steel having fuel supply holes 11 were placed. A fuel tank 12 storing a liquid fuel 13 was provided outside the negative electrode collector plate 9.

In the evaluation tests, oxygen in the air was used as an oxidizing agent, and a 15% by mass methanol aqueous solution was used as the liquid fuel. The single cell for fuel cell evaluation was discharged at a cell temperature of 25° C. so as to measure the maximum output density. Table 1 shows the results of these measurements.

TABLE 1

| | Thickness of each | Catalyst | Maximum |
|---|---|---|---|
| | electrode layer | amount | output density |
| | (μm) | (mg/cm²) | (mW/cm²) |
| Example 1 | Positive electrode | 2 | 18.0 |
| | layer alone: 30 | | |
| | Positive electrode | | |
| | laminate: 65 | | |
| | Negative electrode | | |
| | layer alone: 35 | | |
| | Negative electrode | | |
| | laminate: 75 | | |
| Example 2 | Positive electrode | 3 | 26.0 |
| | layer alone: 30 | | |
| | Positive electrode | | |
| | laminate: 100 | | |
| | Negative electrode | | |
| | layer alone: 35 | | |
| | Negative electrode | | |
| | laminate: 115 | | |
| Example 3 | Positive electrode | 2 | 17.0 |
| | layer alone: 30 | | |
| | Positive electrode | | |
| | laminate: 65 | | |
| | Negative electrode | | |
| | layer alone: 35 | | |
| | Negative electrode | | |
| | laminate: 75 | | |
| Example 4 | Positive electrode | 3 | 26.0 |
| | layer alone: 30 | | |
| | Positive electrode | | |
| | laminate: 100 | | |
| | Negative electrode | | |
| | layer alone: 35 | | |
| | Negative electrode | | |
| | laminate: 115 | | |
| Comparative | Positive electrode | 1 | 10.0 |
| Example 1 | layer alone: 30 | | |
| | Negative electrode | | |
| | layer alone: 35 | | |
| Comparative | Positive electrode | 2 | 12.0 |
| Example 2 | layer alone: 65 | | |
| | Negative electrode | | |
| | layer alone: 75 | | |
| Comparative | (N/A) | — | — |
| Example 3 | | | |

As becomes clear form Table 1, with respect to the amount in Comparative Example 1, Examples 1 to 4 achieved a maximum output density that was increased substantially in proportion to an increase in the catalyst amount. This may be because each electrode layer maintained the porous structure and the structural flawlessness. On the other hand, Comparative Example 2 had a much lower maximum output density than Example 1 with an equal amount of catalyst. Moreover, in Comparative Example 3, it was not even possible to produce the electrode layers as described above. Consequently, it was confirmed that, in order to both thicken the electrode layer and achieve the porous structure and the structural flawlessness of the electrode layer, the layered structure and the layer transferring method according to the present invention were preferred and an electric power generating element for a fuel cell produced in such a manner had excellent cell characteristics.

As described above, the present invention can provide an electric power generating element for fuel cell that can both thicken an electrode layer and achieve a porous structure and a structural flawlessness of the electrode layer, by using an electric power generating element with a structure in which a plurality of electrode layers that are not thicker than a specific thickness are laminated.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description, all changes that come within the meaning and range of equivalency of the claims are intended to be embraced therein.

What is claimed is:

1. An electric power generating element for a fuel cell comprising:
a positive electrode for reducing oxygen;
a negative electrode for oxidizing a fuel; and
a solid electrolyte provided between the positive electrode and the negative electrode;
wherein at least one selected from the positive electrode and the negative electrode comprises a laminate of at least two electrode layers containing a catalyst,
each of the electrode layers has a thickness of at most 50 μm, and an adhesive layer is disposed between the electrode layers.

2. The electric power generating element for a fuel cell according to claim 1, wherein the adhesive layer contains a polymer material having a proton conducting property.

3. The electric power generating element for a fuel cell according to claim 2, wherein the electrode layers contain a polymer material similar to the polymer material contained in the adhesive layer.

4. The electric power generating element for a fuel cell according to claim 1, wherein the catalyst contained in each of the electrode layers has a mass per unit electrode area of 0.3 to 3 mg/cm².

5. The electric power generating element for a fuel cell according to claim 1, wherein the adhesive-layer has a thickness of 1 to 5 μm.

6. The electric power generating element for a fuel cell according to claim 1, wherein the laminate has a total thickness of 30 to 300 μm.

7. An electric power generating element for a fuel cell comprising:
a positive electrode for reducing oxygen;
a negative electrode for oxidizing a fuel; and
a solid electrolyte provided between the positive electrode and the negative electrode;
wherein at least one selected from the positive electrode and the negative electrode comprises a laminate of at least two electrode layers containing a catalyst and a polymer material having a proton conducting property,
each of the electrode layers has a thickness of at most 50 μm, and
the polymer material is present more in an interface part of each of the electrode layers than in an inner part thereof.

8. The electric power generating element for a fuel cell according to claim 7, wherein the catalyst contained in each of the electrode layers has a mass per unit electrode area of 0.3 to 3 mg/cm².

9. The electric power generating element for a fuel cell according to claim 7, wherein the laminate has a total thickness of 30 to 300 μm.

10. A fuel cell comprising:
an electric power generating element for a fuel cell comprising
a positive electrode for reducing oxygen,
a negative electrode for oxidizing a fuel, and
a solid electrolyte provided between the positive electrode and the negative electrode;
wherein at least one selected from the positive electrode and the negative electrode comprises a laminate of at least two electrode layers containing a catalyst,
each of the electrode layers has a thickness of at most 50 μm, and an adhesive layer is disposed between the electrode layers.

11. The fuel cell according to claim 10, wherein the adhesive layer contains a polymer material having a proton conducting property.

12. The fuel cell according to claim 11, wherein the electrode layers contain a polymer material similar to the polymer material contained in the adhesive layer.

13. The fuel cell according to claim 10, wherein the catalyst contained in each of the electrode layers has a mass per unit electrode area of 0.3 to 3 mg/cm².

14. The fuel cell according to claim 10, wherein the adhesive layer has a thickness of 1 to 5 μm.

15. The fuel cell according to claim 10, wherein the laminate has a total thickness of 30 to 300 μm.

16. A fuel cell comprising:
an electric power generating element for a fuel cell comprising
a positive electrode for reducing oxygen,
a negative electrode for oxidizing a fuel, and
a solid electrolyte provided between the positive electrode and the negative electrode;
wherein at least one selected from the positive electrode and the negative electrode comprises a laminate of at least two electrode layers containing a catalyst and a polymer material having a proton conducting property,
each of the electrode layers has a thickness of at most 50 μm, and
the polymer material is present more in an interface part of each of the electrode layers than in an inner part thereof.

17. The fuel cell according to claim 16, wherein the catalyst contained in each of the electrode layers has a mass per unit electrode area of 0.3 to 3 mg/cm².

18. The fuel cell according to claim 16, wherein the laminate has a total thickness of 30 to 300 μm.
